(19) United States
(12) Patent Application Publication
(10) Pub. No.: US 2022/0034669 A1
(43) Pub. Date: Feb. 3, 2022

(54) NAVIGATION ARCHITECTURE FOR CONTESTED ENVIRONMENTS

(71) Applicant: BAE Systems Information and Electronic Systems Integration Inc., Nashua, NH (US)

(72) Inventors: Simone B. Bortolami, Belmont, MA (US); Stephen P. DelMarco, No. Andover, MA (US)

(73) Assignee: BAE Systems Information and Electronic Systems Integration Inc., Nashua, NH (US)

(21) Appl. No.: 16/941,053

(22) Filed: Jul. 28, 2020

(51) Int. Cl. G01C 21/34; G01C 21/28; G01S 19/40

(52) U.S. Cl. CPC G01C 21/3461; G01S 19/40; G01C 21/28

(57) ABSTRACT

A navigation path planning method includes receiving an initial position of a navigation path and a terminal position of the navigation path. The initial position represents a current position of a vehicle or other platform that is navigating to the terminal or target position. The method includes calculating the navigation path from the initial position to the terminal position as an objective function of a navigation reliability term and a navigation accuracy term. The navigation reliability term represents a probability of successfully reaching the terminal position along the navigation path, and the navigation accuracy term represents the probable distance between the terminal position and the navigation path. The calculated navigation path is provided to a navigation system to cause the platform to navigate along the calculated navigation path.

### FIELD OF THE DISCLOSURE

This disclosure relates generally to the field of navigation systems, and more particularly, to techniques for navigation algorithm architectures in contested environments involving path and mission planning.

### BACKGROUND

The Global Positioning System (GPS) is a satellite-based radio-navigation system that provides geolocation and time information to a GPS receiver anywhere on or near the Earth where there is an unobstructed line of sight to enough GPS satellites for obtaining a position fix. GPS has many uses, including providing an aid to positioning and navigation of a host platform, such as an aircraft, helicopter, munition, or other vehicle. For example, an inertial navigation system (INS), which relies on motion sensors to determine position, accumulates error with time and needs recurrent updates from a reliable external source to correct the error. GPS is a ubiquitous navigation aid for providing accurate position updates to the INS.

However, GPS is not available at all locations. For example, GPS signals can be compromised by jamming or spoofing signals or terrestrial interference. Locations where GPS is limited, compromised, or otherwise impaired are referred to as contested environments. In a contested environment, the INS must either rely on expensive hardware to reject GPS jamming or spoofing, or other types of non-GPS navigation aids such as, position fixes on the ground, radio-based positioning, celestial fixes, etc. There are a number of non-trivial issues associated with navigation of the host platform, in contested environments, particularly when GPS is compromised, unavailable, or otherwise impaired.

### BRIEF DESCRIPTION OF THE DRAWINGS

FIG. 1 is a block diagram of an example system for navigation architecture with path planning, in accordance with an embodiment of the present disclosure.

FIG. 2 is a map representing several potential navigation paths over terrain in a contested environment, in accordance with an embodiment of the present disclosure.

FIG. 3 shows a spatial grid laid over a fly-over region of terrain with two example navigation paths, in accordance with an embodiment of the present disclosure.

FIG. 4A shows a flow diagram of an example method of navigation path planning in a contested environment, in accordance with some embodiments of the present disclosure.

FIG. 4B shows a flow diagram of several options that can be used in conjunction with calculating the navigation path in the method of FIG. 4A, in accordance with some embodiments of the present disclosure.

FIG. 5 is a flow diagram of an example method for updating the navigation path while a platform is en route to a path terminal position to maximize the circle of equal probability (CEP or other metrics) at the path terminal position independently of the initial choice of the navigation path, such as described with respect to FIGS. 4A-B, and in accordance with an alternative embodiment of the present disclosure.

### DETAILED DESCRIPTION

Techniques are disclosed for navigation path planning in a contested environment. In accordance with an embodiment of the present disclosure, a navigation path planning method includes receiving an initial or current position of a navigation path and a terminal or target position of the navigation path. The initial position represents a starting or actual position of a vehicle or other host platform that is navigating to the terminal position. At least a portion of the navigation path lies within a contested environment, such as an environment where GPS is not available to update the current position of the platform to account for accumulated navigation (position) error as the platform navigates along the navigation path. The navigation path planning method includes calculating the navigation path from the initial position to the terminal position as an objective function of a navigation reliability term and a navigation accuracy term. The navigation reliability term represents a probability of successfully reaching the terminal position along the navigation path, where the probability of successfully reaching the terminal position is based at least in part on a probability that each of the navigational fixes can be successfully updated. The navigation accuracy term represents a probable distance between the terminal position and the navigation path along the navigation path, which is not necessarily a direct or line-of-sight path. The calculated navigation path is provided to a navigation system to cause the platform to navigate along the calculated navigation path within or through the contested environment.

General Overview

As previously noted, there remain non-trivial issues associated with navigation of a host platform, such as an aircraft or other vehicle, in contested environments where GPS is unavailable or otherwise impaired. In more detail, when GPS is compromised, unavailable, or otherwise impaired at the host platform, a navigation system, such as an inertial navigation system (INS) or other system capable of providing navigation, may navigate the host platform to a position where GPS or another type of navigation aid is available to correct for position errors accumulated in the navigation system. Such a position is referred to in this disclosure as an update opportunity. However, the navigation system must be able to navigate the host platform to the update opportunity before the position error grows too large to successfully reach the update opportunity. In cases where, for an example, a vision-aided navigation is used at the update opportunity, exacerbation ensues when there is limited feature content in acquired imagery, such as with terrain that lacks remarkable features or landmarks or where such visual features and landmarks are obscured by mountains, foliage, persistent fog or haze, or other causes of poor visibility that may prevent the INS from successfully exploiting the update opportunity. In addition to position error and limited update opportunities, the capability of the platform to physically reach an update opportunity can be limited by factors such as fuel, power, speed, maneuverability, weather, operating cost, or other operational conditions. If the host platform cannot successfully reach an update opportunity because of such capability constraints and/or the position error has become too large, the host platform might become irremediably lost.

To this end, enhanced navigation techniques are herein disclosed. While the techniques can be used in a variety of environments, they are particularly well suited for navigating in or through contested environments where GPS is compromised, unavailable, or otherwise impaired. According to an example embodiment of the present disclosure, the techniques can be used to compute a navigation path that is optimized toward or otherwise favors routes within reach of update opportunities that have a high probability of providing accurate navigation fixes. In some embodiments, a vision-aided navigation generates vision measurements by registering imagery, acquired by onboard cameras, to geo-located reference imagery stored in a database. The ability to correctly register a navigation fix from the host platform using vision-aided navigation may be significantly reduced in regions where limited reference imagery is available, where image registration tends to fail, or where image registration has low accuracy. Thus, the disclosed techniques favor regions of high feature content and high registration probability to achieve more accurate update opportunities, thereby increasing the chances of reaching the target destination. Also, in some such embodiments, if the planned route is obstructed by unexpected obstacles or if the platform becomes at risk due to an external threat, the navigation system is programmed or otherwise configured to provide enough options, which can be dynamically updated in flight by new intelligence, to dynamically re-route the platform by trading off opportunities, risks, and/or degrees of mission success.

Navigation Path Planning System

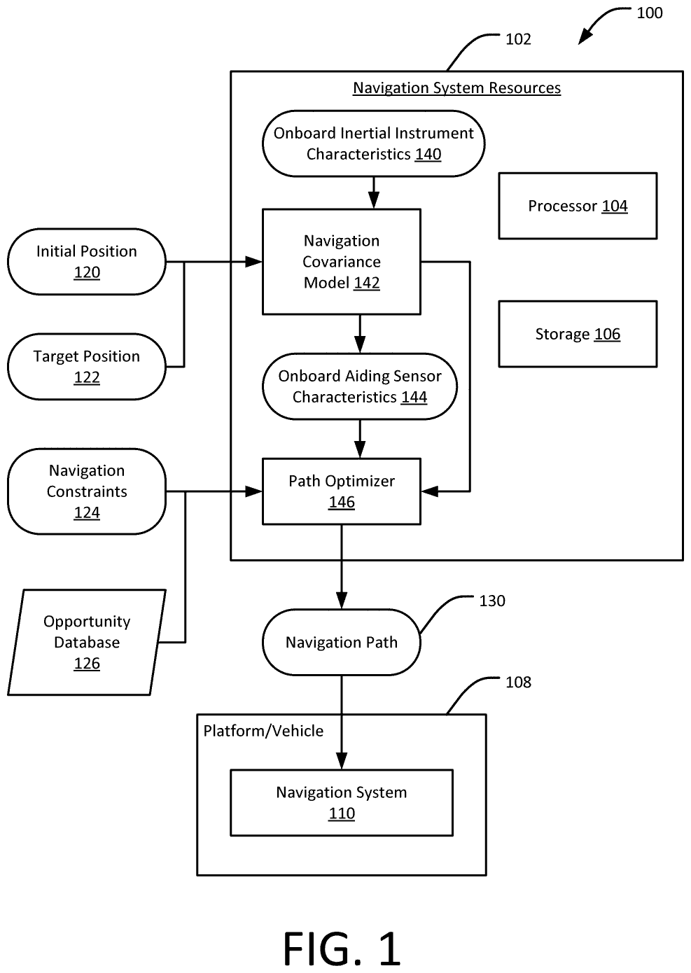

FIG. 1 is a block diagram of an example system architecture 100 for navigation path planning, in accordance with an embodiment of the present disclosure. The system 100 includes navigation system resources 102 configured to generate a navigation path 130. The navigation path 130 can be used by a navigation system 110 of a platform 108 to navigate the platform 108 from an initial or current position 120 to a target or terminal position 122 where at least a portion of the navigation path 130 is within a contested environment. The platform 108 can be any vehicle that is navigating by land, air, or sea. In some embodiments, the navigation system resources 102 are co-located with the platform 108, but it will be understood that the navigation system resources 102 can be located remote from the platform 108, such as the example case where the navigation system resources 102 are on a fixed ground station remotely transmitting and receiving data, including the navigation path 130, to the moving platform 108 via a wireless communication link.

The navigation system resources 102 include one or more processors 104 and a storage 106. The processor(s) 104 can be configured to execute a process for navigation path planning, as variously described herein. The navigation system resources 102 are operatively coupled to, or otherwise interact with, one or more onboard inertial instruments 140 (e.g., accelerometers, gyroscopes), a navigation covariance model 142, one or more onboard aiding sensors 144 (e.g., cameras and machine vision systems), and/or a path optimizer 146 for calculating a navigation path and/or a deviation from the navigation path. In embodiments where the navigation system resources 102 are remote from the platform 108, some or all of these components (e.g., the instruments 140 or the sensors 144) may be located on the platform 108, wherein the remote platform 108 is further configured to transmit data (e.g., communications and sensor data such as imagery) to the remote navigation system resources 102 such that these on-board components are virtually interacting with or otherwise accessible to the platform 108.

In addition to the onboard inertial instruments 140, the navigation covariance model 142, and the onboard aiding sensors 144, the navigation system resources 102 are configured to generate the navigation path 130 based on navigation constraints 124 and an opportunity database 126, such as discussed in further detail below. The navigation constraints 124 represent limitations imposed by the platform 108, including but not limited to available fuel, maximum speed, and maneuverability (e.g., altitude, speed, or course restrictions), according to some example embodiments. In some instances, the navigation constraints 124 represent limitations imposed by the mission, such as usable airspace or terrain (e.g., do not fly zones, other traffic, timing constraints, or restricted or hostile regions). The opportunity database 126 includes information about positions where the navigation system resources 102 can obtain position updates for the platform 108 in environments where GPS is not available. Such opportunities can include, for example, positions where visual landmarks having known geolocations are visible from the platform 108, or where other ground navigation aids (e.g., non-directional beacons (NDB), VHF omnidirectional range (VOR) signals, etc.) can be received by the platform 108. Landmarks having a high registration probability are especially useful for accurate navigation.

Navigation Path Planning Method

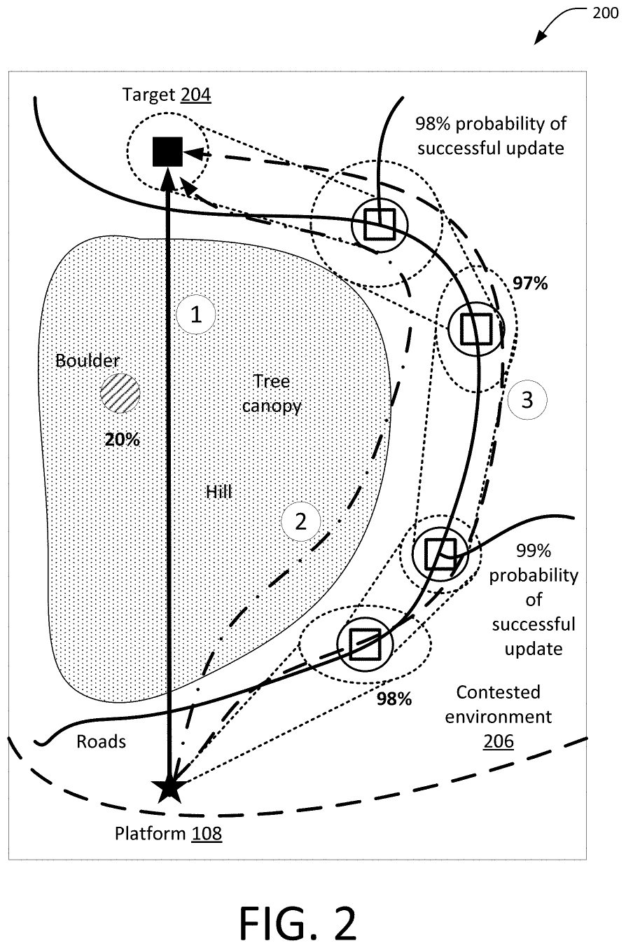

FIG. 2 is a map 200 representing several potential navigation paths over terrain in a contested environment, as computed by navigation system resources 102 for platform 108, in accordance with an embodiment of the present disclosure. The platform 108 is represented by a star icon on the map 200. The platform 108 can be any vehicle that is navigating toward a target 204, by land, air, or sea. For example, the platform 108 can be an autonomous or piloted aircraft or airborne weapon operating at a low to medium altitude (e.g., between 500 and 30,000 feet above sea or ground level) at various speeds (e.g., between about 0.1 and 0.8 Mach) with various mission times (e.g., one- to three-hour). The platform 108 and the target 204 are within a contested environment 206 where GPS signals are not reliably available. The contested environment 206 includes terrestrial features such as a hill, a tree canopy, a large boulder, roads, intersections and other visually identifiable features (e.g., antennas, water towers, buildings, bridges, signs, bodies of water, and other manmade or natural structures) or imagery otherwise recognizable by means of machine vison algorithms. In an example, some of the features, such as the boulder and the intersections, are visually unique and can serve as visual navigation aids to the platform 108 when the positions of such features are known. Other features, such as the tree canopy, are visually unremarkable and therefore provide much less probability of being recognized (registered) as a specific location within a digital map, such as a reference image database. Yet other features, such as the hill, are potential obstructions that must be traversed, overflown, or navigated around.

Several potential navigation paths, indicated as Paths 1, 2, 3, etc., are overlaid on the map 200. Path 1 is a straight-line path from the platform 108 to the target 204, while Path 2 and Path 3 follow more circuitous routes. Not all navigation update opportunities have equal probability of being exploited, or if exploited yield the same navigation accuracy. These two different parameters of all planned opportunities determine the mission reliability, which represents the probability of successfully reaching the target 204 along a navigation path, and the final accuracy, which represents the probable distance between the target 204 and the closest position of the navigation path to the target 204. The probability of successfully reaching the target 204 on a given navigation path is computed based on the quality of landmarks or other navigation fixes observable on that path. The probability of successfully reaching the terminal position is also based, at least in part, on a probability that each of the navigational fixes/updates can be successfully acquired from the platform 108. For an example, an image of a landmark associated with a path, such as a road intersection might be successfully recognized or geo-registered only six times out of ten, while an image of another landmark associated with another path might be geo-registered nine times out of ten because of factors such as varying mission parameters and circumstances. Therefore, if both paths can yield comparable final accuracies and all the other opportunities along the path have comparable reliabilities, the latter path can be favored over the first one when possible. Even though the two different paths can produce comparable final position accuracies, they produce different circles of equal probability (CEPs) for a given host platform and navigation system. The CEP represents the radius of the circle around the target, or destination, where 50% of potential missions of the platform 108 would land or traverse. The reason is that the path having the less reliable update opportunity has higher probability of not working all the time and causes the mission to not reach its final destination with its potential accuracy or at all. Thus, the platform 108 can choose a path associated with the highest probability of success, for a given set of constraints or other factors (such as time remaining to reach destination, remaining fuel, remaining ammunition, to name a few examples) thereby minimizing the mission CEP.

In the example of FIG. 2, the boulder has a registration reliability of 20% (low certainty), while the road intersections have reliabilities between 97% and 99% (high certainty). As shown in FIG. 2, Path 3 passes close to the landmarks with the highest update certainty, but Path 3 is longer than Paths 1 and 2. Thus, while Path 3 provides the highest navigational reliability in the contested environment 206, Path 3 also requires the most distance to be covered between the initial position of the platform 108 and the target 204, which might affect acceptable mission time-to-target and fuel autonomy. Furthermore, Path 3 passes closest to the roads, which in a hostile environment potentially exposes the platform 108 to a greater risk of attack than if the platform 108 crossed over the tree canopy. These factors can reduce the probability of successfully reaching the target thereby affecting the CEP. Path 2, which circumnavigates the hill and tree canopy but is a shorter route than Path 3, represents a compromise between navigational uncertainty, distance, and risk of attack. To calculate each of these paths, a reliability metric (probability of successful exploitation of the update opportunity) is associated with each path, and hence, each opportunity of acquiring a navigation aid and/or reaching the target 204. FIG. 2 and the preceding discussion are examples of the importance of proper path planning to maximize the overall navigation accuracy and reliability—thus minimizing the CEP at the terminal position of the route—by considering the accuracy and probability of exploitation success of every single opportunity associated with each path.

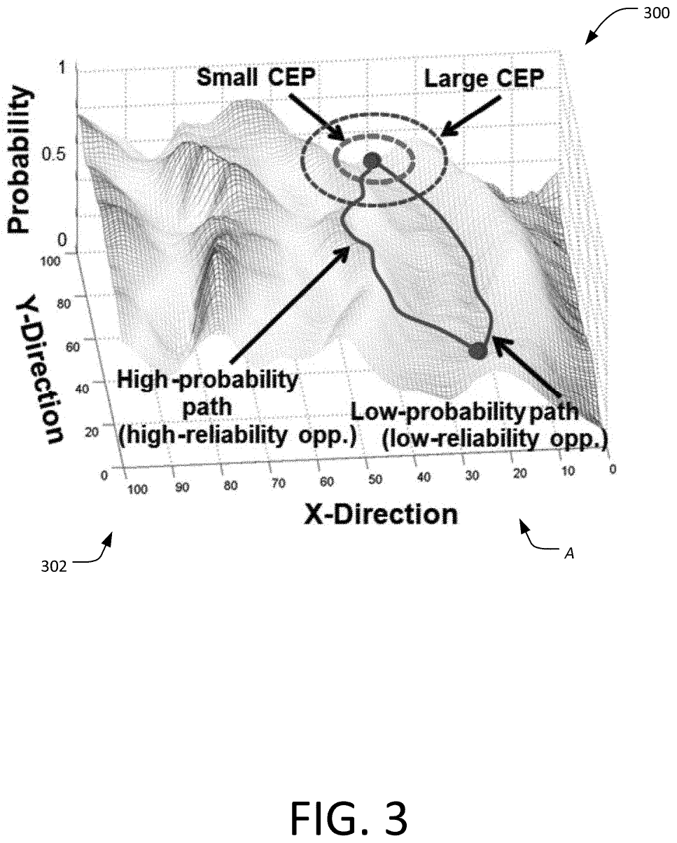

In accordance with an embodiment of the present disclosure, a navigation path is selected by optimizing an objective function (e.g., minimizing a cost function or maximizing a gain function), which is parameterized by one or more variables affecting navigation performance. To define the objective function, a spatial grid is laid over a fly-over region 300 of terrain, such as shown in FIG. 3. Each grid position Pₙ represents the projection of the platform's position P_{I}, P_{T} onto the two-dimensional ground plane 302 of the fly-over region 300. A value associated with each grid position Pₙ represents a probability of obtaining a high-accuracy navigation fix at the platform's location along an extent (length) of a given path within the fly-over region 300. FIG. 3 notionally illustrates two example paths: a high-probability navigation path and a low-probability navigation path. The high-probability navigation route produces a small CEP value at the path terminal position P_{T} because the probability of reaching a high-accuracy navigation fix along the path is maximized or relatively high with respect to other potential paths. The low-probability navigation route produces a large CEP value at the path terminal position P_{T} because the probability of reaching a high-accuracy navigation fix along the path is not maximized or relatively low with respect to other potential paths.

In accordance with an embodiment of the present disclosure, a navigation path planning metric includes a reliability metric objective function. The navigation path planning metric, S_{OPT}, maximizes the product of two components: a navigation reliability term and a navigation accuracy term:

$${S}_{O P T} = {arg max}_{S ⋐ A} [ ( reliability ) ( accuracy ) ]$$

$${S}_{O P T} = {arg max}_{S ⋐ A} [ ( \frac{1}{l ( S )} {\int }_{S} P ( x , y ) ds ) ( \frac{1}{{λ}_{M A X}} ) ]$$

where P(x, y) is the probability of correct updating along the route of path S, x(t) and y(t) the coordinates of S with time over the extent of the path t∈[0, T] (the third coordinate is omitted without lack of generality for ease of treatment), A⊂R² is the spatial region of operation where S is exists, P_{I}, P_{T} are the initial and terminal positions of navigation path (where (x(0), y(0))=P_{T} and (x(T), y(T)=P_{T}), l(S) is the length of the path S, and λ_{MAX} is the maximum eigenvalue of a covariance matrix at the terminal position of path S.

In more detail, the navigation reliability term integrates a probability value P(x, y), derived from a hypothetical update acquisition, which represents the probability of obtaining a navigation fix from a form of aiding measurement (e.g., a camera for imaging one or more geo-located landmarks from the platform 108 or radio bearing or other) of the operation region A for updating either the position, velocity, attitude, or time of the platform. This line integral is normalized by the total path length l(S). For an example, in the case of a vision-aided navigation paradigm, the reliability term drives the optimization toward short paths containing landmarks that can be easily recognized; that is, landmarks that produce a high probability of correct image registration.

In some embodiments, minimum navigation fix probability constraints are imposed over the path. For example, any position along the path must have at least a probability of P_{MIN} for providing a navigation fix. Other constraints, for an example in the case of an aircraft, might relate to an aircraft's realistic capability to fly the path such as maximum turning rates, fuel load, size of the target, and other factors that affect path length, fold into the optimization. For a ground vehicle, they relate to the realistic capability of driving the path. In some embodiments, the optimization can include operating costs factors, such as the cost to complete a mission or a cost associated with a mission failure, where paths that exceed a given cost threshold can be disfavored; likewise, there may be a time-constraint to reach the next update opportunity or the target, and paths that take too long can be disfavored; likewise, there may be a constraint with respect to the limited onboard resources, and paths that involve hostile territory or a specific type of available countermeasures that can be disfavored.

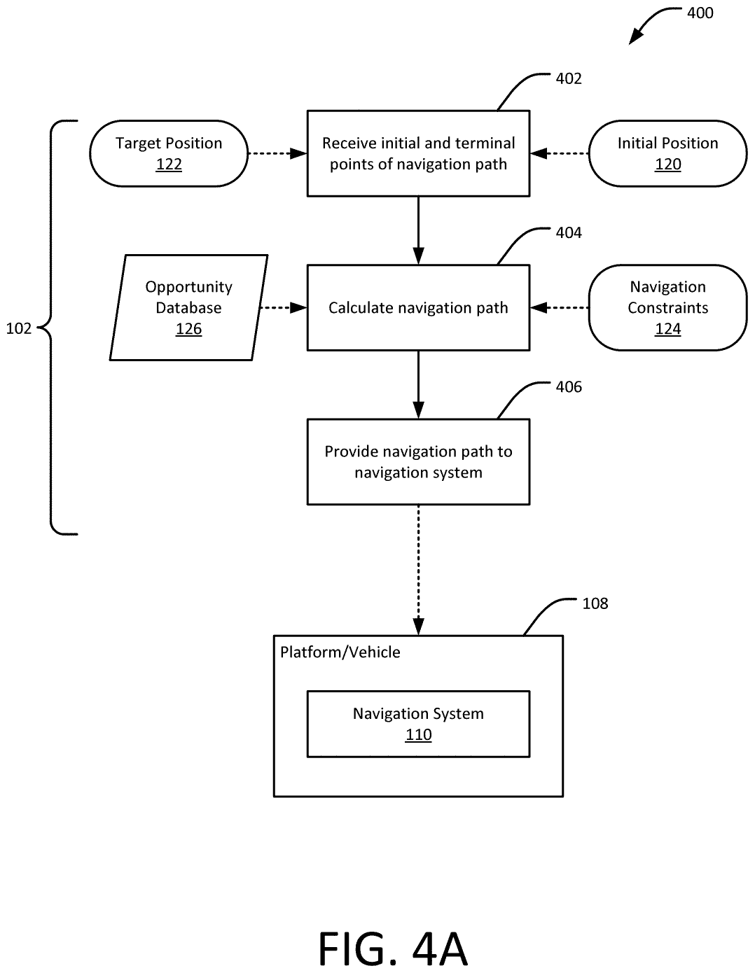

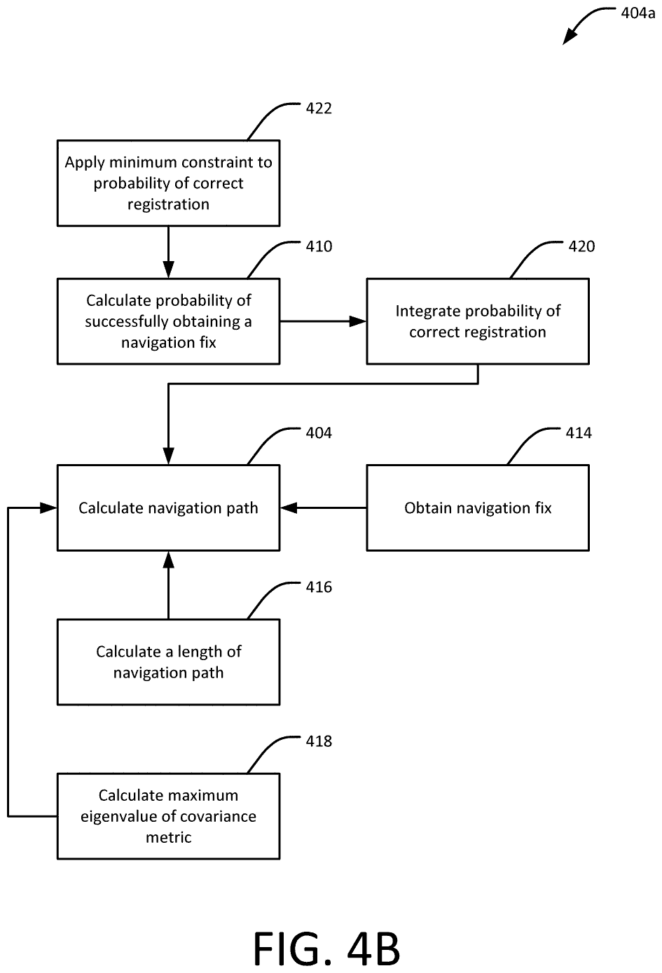

FIG. 4A shows a flow diagram of an example method 400 of navigation path planning in a contested environment, in accordance with some embodiments of the present disclosure. The method 400 can be implemented, in some example embodiments, in the navigational platform 102 of FIG. 1. The method 400 includes receiving 402 an initial position 120 of a navigation path and a terminal position 122 (or target location) of the navigation path (such as P_{I}, P_{T} in FIG. 3). The method 400 further includes calculating 404 the navigation path from the initial position to the terminal position as an objective function of a navigation reliability term and a navigation accuracy term. The calculation 404 incorporates one or more navigation constraints 124 limitations imposed by the platform 108. The navigation reliability term includes information stored in the opportunity database 126 about intermediate positions where the navigational platform 102 can obtain position updates. Such intermediate positions can be used to define a potential path for navigating to the target position 122 via one or more of such intermediate positions, such as described with respect to FIG. 2. In some examples, the objective function navigation path planning metric S_{OPT}, described above, can be used to calculate the navigation path. The navigation reliability term represents a probability of successfully reaching the terminal position along the navigation path, and the final navigation accuracy term represents a probable distance between the terminal position and the navigation path at a closest point to the terminal position. FIG. 3 shows a case for better understanding these concepts, where the high-probability path is primarily in areas where the probability of acquiring updates is very high. Consequently, even though the high-probability path is longer and all other conditions being comparable, it yields a smaller CEP at the target than the shorter low-probability path. This is because if one were to navigate the low-probability path, for example ten times, some updates would not come through. For the sake of explanation, consider that in seven times the target can be reached with the best accuracy because all updates were successfully acquired, two times one update was missed somewhere, which caused the path to pass the target not as close as it could be, and one time the platform after missing the update could not reach the next opportunity before the navigation system completely degraded thereby losing the platform altogether. The CEP is calculated by drawing a circle around the target that represent the area with 50% probability of having the platform ending up the three were the platform using that path. In the case of the high-probability path, for the sake of this explanation, assume that all final positions about the target are comparable to the successful ones of the low-probability path. However, the high-probability path reaches the target with the best accuracy ten times out of ten while the low probability one only seven times. Therefore, the CEP is smaller for the high-probability path.

FIG. 4B shows a flow diagram of several options that can be used in conjunction with calculating 404a the navigation path in the method of FIG. 4A, in accordance with some embodiments of the present disclosure. It will be understood that some or all of these options can be performed at various times during calculation of the navigation path. As noted at 404, the navigation path from the initial position to the terminal position can be calculated as an objective function of a navigation reliability term and a navigation accuracy term. In some embodiments, and with reference to FIG. 4B, the methodology at 404 of this example embodiment includes calculating 410 a probability of successfully obtaining a navigation fix over a given position along the navigation path, where the navigation reliability term includes the probability of correct registration. For example, a visual navigation aid, such as an image of a landmark on the ground taken from a camera on board the host platform, can be used as an update opportunity. The captured image of the visual navigation aid is compared to (registered with) a database of visual navigation aids whose geopositions are known. However, because the camera angle, image resolution, lighting, visibility, distinctiveness of the landmark, and other environmental factors can affect the ability to register the captured image to the database, there may be a less than 100% chance of correctly registering the visual navigation aid in the image to the corresponding visual navigation aid in the database 126. In some such embodiments, the methodology at 404 further includes integrating 420 the probability of correct registration of the navigation aid over a plurality of positions along the navigation path. For example, in the objective function navigation path planning metric S_{OPT}, described above, P(x, y) is the probability of correct registration when the platform is above ground position (x, y) integrated over a plurality of positions along and defining the navigation path. However, it will be understood that it is not always necessary to integrate 420 the probability of correct registration, such as when a linear function (e.g., average) is used or when the probabilities are the same for multiple positions along the navigation path.

In some example embodiments, the methodology at 404 includes obtaining 414 a navigation fix from a vision-based measurement of a region of terrain in the contested environment (e.g., an image of the ground taken from the platform), where the probability of correct registration is based on the navigation fix. It will be understood that non-visual navigation fixes can be utilized, such as radio beacons, celestial fixes, radio frequency (RF) ranging, and other non-GPS navigation aids, which do not require registration against a database of visual navigation aids but can be registered against or otherwise compared to other databases or sources that provide geolocation data for those fixes (such as the geolocation of a VOR beacon). It will be understood that it is not always necessary to obtain 414 the navigation fix, such as during periods while the position error is less than a threshold value or while the platform is out of range of any update opportunity.

In some example embodiments, the methodology at 404 includes applying 422 a minimum constraint value to the probability of correct registration. The minimum constraint value can be arbitrarily chosen and effectively removes low probability update opportunities from consideration during the calculation 404 of the navigation path. For example, the minimum constraint value can represent the probability of correct registration of one or more navigation fixes for a given navigation path, which is based on one or more limitations imposed by the platform, including but not limited to available fuel, maximum speed, and maneuverability (e.g., altitude, speed, or course restrictions), and/or one or more limitations imposed by the mission, such as usable airspace or terrain (e.g., do not fly zones, other traffic, timing constraints, or restricted or hostile regions). It will be understood that in some embodiments, use of the minimum constraint value is not necessary if no constraints are available or if all probabilities are to be considered.

In some embodiments, the methodology at 404 further includes calculating 416 a length of the navigation path between the initial position and the terminal position, where the navigation reliability term further includes the length of the navigation path. Generally, the navigation reliability term is inversely proportional to the length of the navigation path, since the ability to accurately navigate in a GPS contested environment decreases as the distance between the current position of the platform and the target position increases. Furthermore, in some instances, a greater navigation path length can be detrimental to the mission because it may require more time and/or fuel to reach the target position or the navigation path length may be constrained by other factors such as weather and other operating conditions. Therefore, the navigation reliability term can be normalized according to the path length, in some examples. It will be understood that it is not always necessary to calculate 416 the path length if such normalization is not needed or desired, such as when the path length is not a limiting factor for a given mission.

In some embodiments, the methodology at 404 further includes calculating 418 a maximum eigenvalue of a covariance metric at the terminal position, where the navigation accuracy term includes the maximum eigenvalue of the covariance metric at the terminal position. As noted above, maximizing the reciprocal of the maximum eigenvalue of the navigation spatial covariance at the path terminal position minimizes the CEP value, and therefore increases the reliability that the platform will reach the target position. It will be understood that it is not always necessary to calculate 418 the maximum eigenvalue of the covariance metric, such as in situations where the CEP of the terminal position is large relative to the accuracy of the navigation path, and thus the accuracy term is relatively high (near or equal to 1).

In some embodiments, the objective function is defined with respect to a spatial grid laid over a region of terrain in the contested environment, such as shown in FIG. 3, where the initial position, the terminal position, and the given position along the navigation path are positions on the spatial grid.

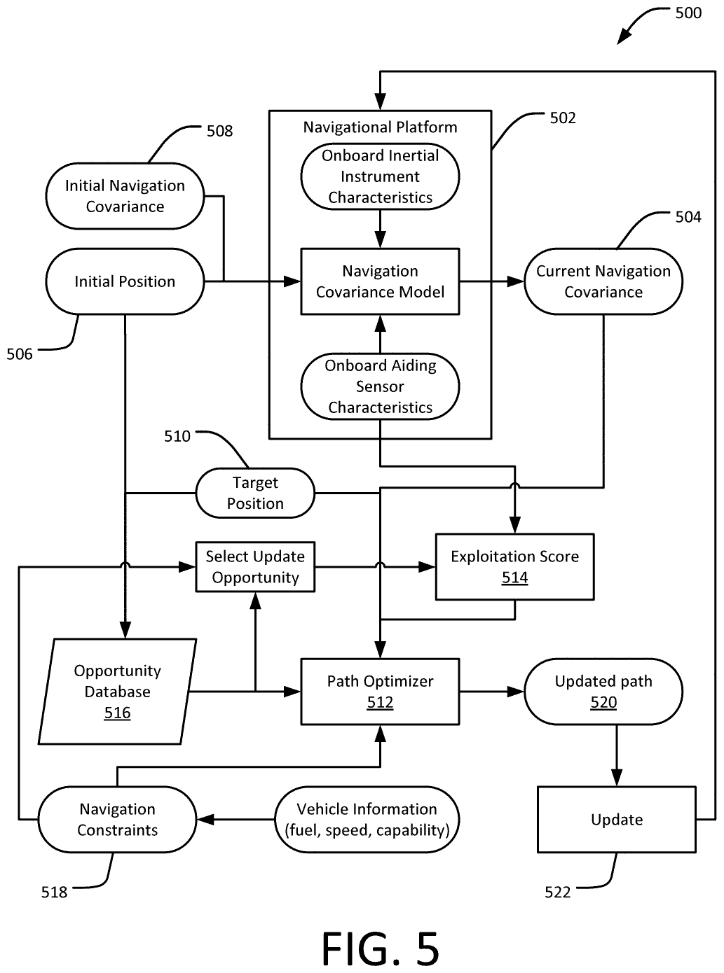

FIG. 5 is a flow diagram of an example method 500 for updating a navigation path while a platform is en route to a path terminal position, in accordance with an embodiment of the present disclosure. The method 500 can be used, for example, to maximize the CEP at the path terminal position in a GPS contested environment independently of the initial choice of the navigation path, such as described with respect to FIG. 4. The method 500 uses reliability, platform, and onboard navigation system information in conjunction with a database of update opportunities to periodically or continuously update the navigation path as the platform proceeds toward the target or destination.

The method 500 interacts with a navigational platform 502 that provides data from onboard inertial instruments (e.g., heading, altitude, and speed), a navigation covariance model, and onboard aiding sensors (e.g., vision-aided navigation sensors). In some embodiments, the navigation covariance model can be constructed by taking bearing measurements of ground objects detected by the onboard aiding sensors, where the ground objects have known geolocations. The uncertainty of the inertial navigation system, or the current navigation covariance 504, can be determined using covariance analysis based on the geolocations of the detected ground objects in combination with the initial position 506 of the platform and the initial navigation covariance 508.

The current navigation covariance 504, a target location 510, an exploitation score 514, and one or more navigation constraints 518 are provided to a path optimizer 512. The path optimizer 512 calculates any deviations to the current navigation path, such as deviations for reaching an update, opportunity in a GPS contested environment. The exploitation score 514 represents an update opportunity selected from a database of update opportunities 516 in combination with data from the onboard aiding sensors. The database of update opportunities 516 represents positions at which the navigational platform 502 can successfully update the position of the platform in a GPS contested environment by using non-GPS navigation aids (e.g., visual aids). For example, the exploitation score 514 can represent a degree to which an update opportunity can be used in conjunction with data from the navigation platform 502, where a higher score indicates a greater chance of successfully reaching and using the given update opportunity. The navigation constraints 518 represent one or more constraints imposed by the platform, such as available fuel, speed, or other capability (such as maneuvering capability) that may limit the ability of the platform to reach any given update opportunity. The path optimizer 512 considers the exploitation score 514 and the navigation constraints 518 when selecting an updated path 520. The updated path 520 can include a deviation from the initial navigation path or any previous deviations therefrom. The deviations can, for example, involve rerouting the platform to a different update opportunity based on any of the factors discussed above, including the current navigation covariance 504, the target location 510, the exploitation score 514 of a selected update opportunity, and/or the navigation constraints 518. The method 500 includes updating 522 the navigational platform 502 with the updated path 520. The method 500 can repeat any number of times as the platform navigates toward the target location 510 within a GPS contested environment.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the navigation path planning methodologies disclosed herein to be implemented. The instructions can be encoded using a suitable programming language, such as C, C++, object-oriented C, Java, JavaScript, Visual Basic .NET, or alternatively, using custom or proprietary instruction sets. The instructions can be provided in the form of one or more computer software applications and/or applets that are tangibly embodied on a memory device, and that can be executed by a computer having any suitable architecture. The computer software applications disclosed herein may include any number of different modules, sub-modules, or other components of distinct functionality, and can provide information to, or receive information from, still other components. Other componentry and functionality not reflected in the illustrations will be apparent in light of this disclosure, and it will be appreciated that other embodiments are not limited to any particular hardware or software configuration. Thus, in other embodiments, additional, fewer, or alternative subcomponents can be provided as compared to those included in the example embodiment of FIG. 1.

The non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine-readable medium or article, which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CR-RW) memory, optical disk, magnetic media, magneto-optical media, removable memory cards or disks, various types of digital versatile disk (DVD), a tape, a cassette, miniSD, microSD, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or other similar terms refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system on-chip (SoC), etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), ARM processor, logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Additional Examples

Numerous embodiments will be apparent in light of the present disclosure, and features described herein can be combined in any number of configurations. An example embodiment provides a method of navigation path planning in a contested environment. The method includes receiving an initial position of a navigation path and a terminal position of the navigation path and calculating the navigation path from the initial position to the terminal position as an objective function of a navigation reliability term and a navigation accuracy term. The navigation reliability term represents a probability of successfully reaching the terminal position via one or more navigational fixes to be obtained from a platform while navigating along the navigation path. The probability of successfully reaching the terminal position is based at least in part on a probability that each of the navigational fixes can be successfully obtained while navigating along the navigation path. The navigation accuracy term represents a distance between the terminal position and the navigation path. The method further includes providing the calculated navigation path to a navigation system to cause the platform to navigate along the calculated navigation path. In some cases, during navigation along the calculated navigation path, the method includes receiving an image of at least one of the navigational fixes; comparing one or more features of the image to one or more corresponding features of a reference image associated with a known geolocation; and registering the at least one navigational fix based on the comparison; and providing the at least one navigation fix to the navigation system. In some such cases, the method includes updating the navigation path to account for accumulated navigation error of the navigation system based on the at least one navigation fix. In some such cases, the navigation system includes a global positioning satellite (GPS) receiver, and the calculated navigation path is provided to the navigation system while GPS-based navigation is unavailable. In some cases, the method includes calculating a maximum eigenvalue of a covariance metric at the terminal position, where the accuracy term includes the maximum eigenvalue of the covariance metric at the terminal position. In some cases, the method includes calculating a probability of correct registration of a visual navigation aid at a given position along the calculated navigation path, where the navigation reliability term includes the probability of correct registration, and where the method further comprises one, two, or all three of: applying a minimum constraint value to the probability of correct registration; integrating the probability of correct registration of the navigation aid over a plurality of positions along the navigation path; and/or calculating a length of the navigation path between the current position and the terminal position, where the navigation reliability term further accounts for the length of the navigation path. In some cases, the objective function is defined with respect to a spatial grid laid over a region of terrain in a contested environment, where the initial position, the terminal position, and the given position along the navigation path are positions on the spatial grid.

Another example embodiment provides a system for navigation path planning in a contested environment. The system includes one or more processors and a storage operatively coupled to the one or more processors and configured to store instructions that when executed by the one or more processors cause a process to be carried out. The process includes receiving an initial position of a navigation path and a terminal position of the navigation path and calculating the navigation path from the initial position to the terminal position as an objective function of a navigation reliability term and a navigation accuracy term. The navigation reliability term represents a probability of successfully reaching the terminal position along the navigation path. The navigation accuracy term represents a distance between the terminal position and the navigation path. The process further includes providing the calculated navigation path to a navigation system to cause a platform to navigate along the calculated navigation path. In some cases, the process includes calculating a maximum eigenvalue of a covariance metric at the terminal position, where the accuracy term includes the maximum eigenvalue of the covariance metric at the terminal position. In some cases, the process includes calculating a probability of correct registration of a navigation aid over a given position along the navigation path, where the navigation reliability term includes the probability of correct registration. In some cases, the process includes obtaining a navigation fix from a vision-based measurement of a region of terrain, where the probability of correct registration is based on the navigation fix. In some cases, the process includes one, two, or all three of: applying a minimum constraint value to the probability of correct registration; integrating the probability of correct registration of the navigation aid over a plurality of positions along the navigation path; and/or calculating a length of the navigation path between the initial position and the terminal position, where the navigation reliability term further includes the length of the navigation path. In some cases, the objective function is defined with respect to a spatial grid laid over a region of terrain in the contested environment, where the initial position, the terminal position, and the given position along the navigation path are positions on the spatial grid. Yet another example embodiment provides a computer program product including one or more non-transitory machine-readable mediums encoded with instructions that when executed cause the process for navigation path planning described above to be carried out.

The foregoing description and drawings of various embodiments are presented by way of example only. These examples are not intended to be exhaustive or to limit the invention to the precise forms disclosed. Alterations, modifications, and variations will be apparent in light of this disclosure and are intended to be within the scope of the invention as set forth in the claims.

What is claimed is:

1. A method of navigation path planning in a contested environment, the method comprising:
receiving an initial position of a navigation path and a terminal position of the navigation path;
calculating the navigation path from the initial position to the terminal position as an objective function of a navigation reliability term and a navigation accuracy term, the navigation reliability term representing a probability of successfully reaching the terminal position via one or more navigational fixes to be obtained from a platform while navigating along the navigation path, wherein the probability of successfully reaching the terminal position is based at least in part on a probability that each of the navigational fixes can be successfully obtained while navigating along the navigation path, and the navigation accuracy term representing a distance between the terminal position and the navigation path; and
providing the calculated navigation path to a navigation system to cause the platform to navigate along the calculated navigation path.

2. The method of claim 1, wherein during navigation along the calculated navigation path, the method comprises:
receiving an image of at least one of the navigational fixes;
comparing one or more features of the image to one or more corresponding features of a reference image associated with a known geolocation;
registering the at least one navigational fix based on the comparison; and
providing the at least one navigation fix to the navigation system.

3. The method of claim 2, further comprising updating the navigation path to account for accumulated navigation error of the navigation system based on the at least one navigation fix.

4. The method of claim 3, wherein the navigation system includes a global positioning satellite (GPS) receiver, and the calculated navigation path is provided to the navigation system while GPS-based navigation is compromised, unavailable, or otherwise impaired.

5. The method of claim 1, comprising calculating a maximum eigenvalue of a covariance metric at the terminal position, wherein the accuracy term includes the maximum eigenvalue of the covariance metric at the terminal position.

6. The method of claim 1, comprising calculating a probability of correct registration of a visual navigation aid at a given position along the calculated navigation path, wherein the navigation reliability term includes the probability of correct registration, and wherein the method further comprises one, two, or all three of:
applying a minimum constraint value to the probability of correct registration;
integrating the probability of correct registration of the navigation aid over a plurality of positions along the navigation path; and/or
calculating a length of the navigation path between the current position and the terminal position, wherein the navigation reliability term further accounts for the length of the navigation path.

7. The method of claim 1, wherein the objective function is defined with respect to a spatial grid laid over a region of terrain in a contested environment, wherein the initial position, the terminal position, and the given position along the navigation path are positions on the spatial grid.

8. A system for navigation path planning in a contested environment, the system comprising:
one or more processors; and
a storage operatively coupled to the one or more processors and configured to store instructions that when executed by the one or more processors cause a process to be carried out, the process including:
receiving an initial position of a navigation path and a terminal position of the navigation path;
calculating the navigation path from the initial position to the terminal position as an objective function of a navigation reliability term and a navigation accuracy term, the navigation reliability term representing a probability of successfully reaching the terminal position along the navigation path, the navigation accuracy term representing a distance between the terminal position and the navigation path; and
providing the calculated navigation path to a navigation system to cause a platform to navigate along the calculated navigation path.

9. The system of claim 8, wherein the process includes calculating a maximum eigenvalue of a covariance metric at the terminal position, wherein the accuracy term includes the maximum eigenvalue of the covariance metric at the terminal position.

10. The system of claim 8, wherein the process includes calculating a probability of correct registration of a navigation aid over a given position along the navigation path, wherein the navigation reliability term includes the probability of correct registration.

11. The system of claim 8, wherein the process includes obtaining a navigation fix from a vision-based measurement of a region of terrain, wherein the probability of correct registration is based on the navigation fix.

12. The system of claim 8, wherein the process includes one, two, or all three of:
applying a minimum constraint value to the probability of correct registration;
integrating the probability of correct registration of the navigation aid over a plurality of positions along the navigation path; and/or
calculating a length of the navigation path between the initial position and the terminal position, wherein the navigation reliability term further includes the length of the navigation path.

13. The system of claim 8, wherein the objective function is defined with respect to a spatial grid laid over a region of terrain in the contested environment, wherein the initial position, the terminal position, and the given position along the navigation path are positions on the spatial grid.

14. A computer program product including one or more non-transitory machine-readable mediums encoded with instructions that when executed cause a process to be carried out for navigation path planning, the process comprising:
receiving an initial position of a navigation path and a terminal position of the navigation path;
calculating the navigation path from the initial position to the terminal position as an objective function of a navigation reliability term and a navigation accuracy term, the navigation reliability term representing a probability of successfully reaching the terminal position via one or more navigational fixes to be obtained from a platform while navigating along the navigation path, wherein the probability of successfully reaching the terminal position is based at least in part on a probability that each of the navigational fixes can be successfully obtained while navigating along the navigation path, and the navigation accuracy term representing a distance between the terminal position and the navigation path;
receiving an image of at least one of the one or more navigational fixes;
comparing one or more features of the image to one or more corresponding features of a reference image associated with a known geolocation;
registering the at least one navigational fix based on the comparison; and
providing the at least one navigation fix to the navigation system.

15. The computer program product of claim 14, wherein during navigation along the calculated navigation path, the process further comprises:
providing the calculated navigation path to a navigation system to cause the platform to navigate along the calculated navigation path.

16. The computer program product of claim 15, wherein the process further comprises updating the navigation path to account for accumulated navigation error of the navigation system based on the navigation fix.

17. The computer program product of claim 16, wherein the navigation system includes a global positioning satellite (GPS) receiver, and wherein the calculated navigation path is provided to the navigation system while GPS-based navigation is compromised, unavailable, or otherwise impaired.

18. The computer program product of claim 14, wherein the process comprises calculating a maximum eigenvalue of a covariance metric at the terminal position, and wherein the accuracy term includes the maximum eigenvalue of the covariance metric at the terminal position.

19. The computer program product of claim 14, wherein the process comprises calculating a probability of correct registration of a visual navigation aid at a given position along the calculated navigation path, wherein the navigation reliability term includes the probability of correct registration, wherein the method further comprises one, two, or all three of:
applying a minimum constraint value to the probability of correct registration;
integrating the probability of correct registration of the navigation aid over a plurality of positions along the navigation path; and/or
calculating a length of the navigation path between the current position and the terminal position, wherein the navigation reliability term further accounts for the length of the navigation path.

20. The computer program product of claim 14, wherein the objective function is defined with respect to a spatial grid laid over a region of terrain in a contested environment, wherein the initial position, the terminal position, and the given position along the navigation path are positions on the spatial grid.
